(19) United States
(12) Patent Application Publication
(10) Pub. No.: US 2005/0231758 A1
(43) Pub. Date: Oct. 20, 2005

(54) Systems and methods relating to paper and printer cartridge usage

(76) Inventor: Christopher H. Reynolds, Wayland, MA (US)

Correspondence Address: WILMER CUTLER PICKERING HALE AND DORR LLP, 60 STATE STREET, BOSTON, MA, 02109, US

(21) Appl. No.: 11/052,436

(22) Filed: Feb. 7, 2005

Related U.S. Application Data
(60) Provisional application No. 60/542,360, filed on Feb. 6, 2004.

(51) Int. Cl. G06K 15/02

(52) U.S. Cl. 358/1.15

(57) ABSTRACT

A system and method are disclosed that may used to significantly reduce the costs of printing documents. This will involve the use of remanufactured printer cartridges and printing only changed pages after the first printing of a particular document. The system and method also will permit an accurate determination of printing costs based on the incremental price of the paper and the cost the ink/toner necessary for printing each page of a document. The system and method may be carried out in a computer-based system with a connected printer, and the computer-based system connects to a central system.

### FIELD OF THE INVENTION

The present invention relates to systems and methods for providing greater control over printer usage and improving the paper and printer cartridge usage.

### BACKGROUND OF THE INVENTION

Many businesses and homes use computers in everyday activities. In the course of these activities, many computer users have dedicated or networked printers to print their work. Typically, these printers are laser or ink jet printers. In many cases, the printers, no matter the size and capability, are relatively inexpensive compared to the value of the printer supplies purchased for these printers during their lives. These printer supplies primarily include paper and ink or toner cartridges.

A printer manufacturer may sell a small printer for $50.00 (US) to $200.00 (US); however, a replacement printer cartridge may cost up to $300.00 (US). The profit margins on printer cartridges can range from 15% to 75%. Moreover, the profit ratio of printer supplies (paper and toner) to the cost of a printer may be as much as 20:1. Generally, the printer expenditures will exceed the printer cost approximately three new printer cartridges. Given this, some printer manufacturers may sell the printers at a loss to capture a printer cartridge customer.

Businesses and homes usually select between two primary types of printers. These are “black and white” and “color” printers. One of the main differences between the printer cartridges for these printers is that the color cartridges are more expensive. Because of this, many businesses have restricted the use of color printers by their employees or have attempted to institute methods of tracking their use so that employees are charged for using them for personal use. However, many of the companies have found that current monitoring technology is very ineffective.

In order to overcome some of the high cost of printer cartridges, a number of companies have developed products that will refill these cartridges, while other companies have entered the business of remanufacturing the cartridges. These aftermarket printer cartridges can be sold at a savings of 20% to 50% compared to the average selling price of new printer cartridges. In recent years, aftermarket printer cartridges have accounted for as much as 27% of the market for monochrome laser printer cartridges. Similarly, the demand for aftermarket printer cartridges for color laser printers is rising and is currently above 20%. The growth of aftermarket inkjet printer cartridges is expected to follow this trend.

To cut costs, the U.S. Government is using aftermarket remanufactured or recharged printer cartridges. This also applies to many large companies that see the real cost benefits in using these cartridges, especially, those that have a very large numbers of printers. The use of remanufactured or recharged printer cartridges also is catching on with smaller companies and individuals who are realizing the significant cost savings by using them. This trend among individuals is expected to continue in light of the ever-increasing number of personal printers that are being sold today and projected to be sold in the future.

Printer manufacturers who sell new cartridges have seen the erosion of profits attributed to the sales of aftermarket remanufactured or recharged printer cartridges. These manufacturers have retaliated by equipping some of their printers with electronic “lock-out” chips that make certain recharged cartridges incompatible with their printers. These manufacturers also have required customers to cycle spent cartridges back to them. Further, some printer manufacturers have made it a breach of warranty to use remanufactured or recharged printer cartridges in their printers.

Currently, there are approximately 8000 companies in the United States that sell remanufactured or recharged printer cartridges. Approximately 30% of the toner cartridges and 17% of the inkjet cartridges are remanufactured or recharged. However, it has been found by both companies and individuals that all remanufactured or recharged printer cartridges “are not the same,” i.e., not all the remanufactured and recharged printer cartridges have the same or similar quality as new printer cartridges. Usually, this is not discovered until the user has purchased and begun using such printer cartridges. The printing quality of remanufactured or recharged printer cartridges also may not be discovered immediately, because some aftermarket sellers may have first “baited” the company or individual with printer cartridges of reasonable quality and then when a large purchase is made, it is then discovered that many of the remanufactured or recharged printer cartridges are of low or very low quality.

There is the need for an effective method for printer users to understand the options that are available for obtaining high quality remanufactured or recharged printer cartridges. This may include access to new user promotions for testing remanufactured or recharged printer cartridges, streamlining of the purchase process of remanufactured or recharged printer cartridges, and providing useful feedback regarding the quality of particular remanufactured or recharged printer cartridges.

There are estimates by industry groups that at present each employee of a reasonable size company will print approximately 10,000 pages per year. This number is increasing even though there has been the push for offices to become more paperless. It is plain that any reverse in this trend would be welcomed because the savings will go directly to the bottom line.

The savings that have been discussed thus far have been directed primary to savings of ink/toner and paper. However, it also must be understood that with the reduction in paper and ink/toner, there also will be increased savings in storage costs for printer supplies and printed documents, and savings in the requirements needed for the disposal of printed materials.

When printing services are sold for a fee, the cost for printing a page is based on the cost of the paper and the amount of ink/toner used for printing the page. Typically, this is reduced to one flat fee for “black and white” pages and another “color” print pages. These flat fees are an average of the cost of printing “black and white” and “color” pages. This can, in fact, cause problems for the printing services provider because ink/toner coverage per page varies with each page. As such, the printing services provider can lose money using this flat fee approach if the coverage is more than average. If there were a method to determine the exact amount of coverage per print page, then there could be accurate determination of what should be charged per page and the printing services provider would not be required to rely only on the flat fee scheme currently being used.

These and other problems are overcome by the system and method of the present invention.

### SUMMARY OF THE INVENTION

The present invention is a system and method for controlling the printing of pages by a printer preferably using the remanufactured or recharged (hereinafter “remanufactured”) printer cartridges. The present invention will result in significant savings in printing supplies, i.e., paper and printer cartridges for the user. This also will provide increased savings in the need for storage space and disposal capabilities. The present invention also provides a method for tracking the quality of printing by remanufactured printer cartridges. This will include determining the quality of printing based on aggregated empirical statistics relating to a particular remanufactured printer cartridge. The present invention also will record the number of pages that are printed and the number of pages that were saved from being printed. The present invention also permits equating paper savings to the actual savings of natural resources, such as the number of trees saved, the number of carbon credits earned, or greenhouse gases avoided by a particular system user's reduction in paper usage. This tracking may be used for basing discount program incentives for system users.

The system and method of the present invention aggregates feedback from system users regarding the quality of particular remanufactured printer cartridges so that a central system will provide system users with at least a ranking of remanufactured printer cartridges according to quality and dependability. This will provide old and new system users with a baseline of information on which to rely in making decisions as to remanufactured printer cartridge products to purchase.

The system and method of the present invention will provide the system user with up-to-date, accurate information regarding the amount of energy, pulp, and paper that have been conserved, and this information may be displayed. The system and method of the present invention also may make recommendations of printer suppliers to system users to meet internal user goals or achieve certain environmental goals set by a State or the Federal Government.

The system and method of the present invention may be implemented through computer software which may be in the form of an applet that resides on the computer that connects to a printer. The present invention will capture the print stream to monitor all printing activities. The capture of the print stream will permit the present invention to do a number of things. Among other things, it will permit the system user to detect pages of a document that have changed since the last time the document was printed. This will give the system user the option to print only the “changed pages,” which will result in a significant savings in printing supply costs.

The capture of the print stream also will permit the present invention to signal when printing supplies are needed. The present invention can provide the system user options for replenishing the printer supplies according to user criteria or other external criteria, e.g., state regulations.

The information provided by the central system back to system users may include options based on the measurements of printer usage savings, or special promotions and discounts through arrangements with partners. The communications between the central system and the system users preferably is via a global communications network, such as the Worldwide Web or the Internet.

The present invention will be described in greater detail in the remainder of this specification referring to the drawings where appropriate.

### BRIEF DESCRIPTION OF THE DRAWINGS

FIG. 1 is a block diagram of a first system incorporating the system and method of the present invention.

FIG. 2 is a block diagram of a second system incorporating the system and method of the present invention.

FIG. 3 is a flow diagram of the operation of the applet according to the system and method of the present invention.

FIG. 4 is a representative computer display printing icon according to the system and method of the present invention.

FIG. 5 is a representative computer display information icon according to the system and method of the present invention.

FIG. 6 is a representative computer display post-printing icon according to the system and method of the present invention.

### DETAILED DESCRIPTION OF THE PRESENT INVENTION

The present invention is a system and method for controlling the printing of documents. Preferably, the printer uses remanufactured printer cartridges to provide the system user with significant savings in printing supplies. The present invention also tracks the quality of printing results by remanufactured printer cartridges through system user feedback. This feedback may result in the central system making ranking determinations based on the quality of printing which are based on aggregated empirical statistics from the system users for particular remanufactured printer cartridges. The present invention will record of the number of pages that were printed and the number of pages that were saved from being printed. The number of pages saved from being printed will be equated to actual savings of natural resources e.g., the number trees saved based on the number pages saved. This tracking will provide a method for basing discount programs in which system users are rewarded for their savings.

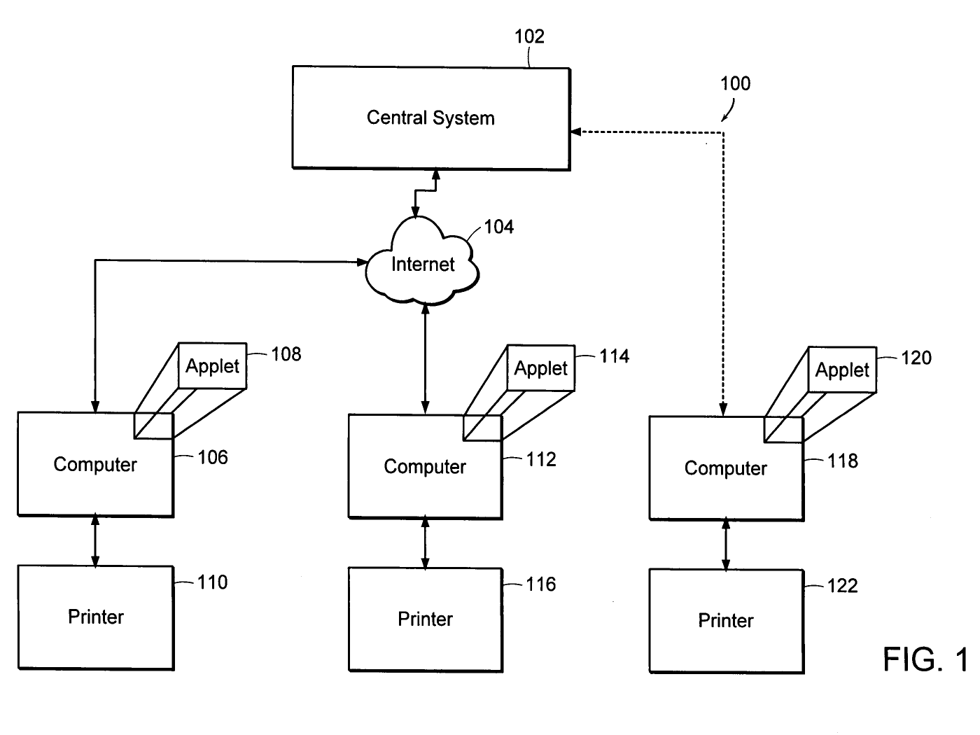

Referring to FIG. 1, generally at 100, a block diagram is shown of a system that incorporates the system and method of the present invention. According to the present invention, central system 102 may be connected to each of the system users that avail itself of the present invention. The central system is configured as a logical network node or nodes comprising a computer system with associated database and memory for information storage and software distribution. The central system has two subsystems: (i) a subsystem that receives and aggregates usage parameters from system users in order to prepare empirical reports for users regarding performance measurements such as ink/toner cartridge quality, the number of standard pages printed per cartridge, the effective cost per page, the proportion of color pages, the total pages spared, etc; and (ii) a subsystem from which new users may download the applet on a trial or permanent basis and existing users may receive software and data updates (sometimes termed “patches”) that will allow the upgrading, expansion, or termination of system functionality.

The central system may be connected to the each system user for the exchange of the information between the system users and the central system. The exchange will include, but not be limited to, (i) feedback information from system users to the central system and (ii) the central system providing discount information, performance information, or recommendations to the system users. Further, the central system may provide a variety of support services to the system users over the communications link.

The connection between central system 102 and system user computers, such as representative computers 106, 112, and 118, may be via a global communications system, such as the Internet 104 for user computers 106 and 108, or by other means, such a land line link, as shown for user computer 118. The system and method of the present invention also contemplates that there may be nondedicated links between a system user and central system 102. For example, the system user may contact the central system on an “as needed” basis, by telephone for an exchange of information between that system user and the central system. This may be accomplished automatically, for example, by use of a modem, or by the system user actually calling the central system.

The system user's computer and printer do not have to connect to the central system. In fact, once the applet has been loaded into the system user's computer, such as via a CD, the present invention can operate successfully to reduce printing costs by having the ability to print changed pages and experience savings of paper and ink/toner printer cartridges.

An example of feedback information provided to central system 102 from the system users is the following. The three system users in FIG. 1 all may have used four different types of remanufactured printer cartridges. Each of them will send their evaluations of these products to the central system for ranking their quality and dependability. Each of the system users also may have provided other information about the attributes of the remanufactured printer cartridges to the central system. The central system thereafter aggregated the information received from the three system users and ranked the remanufactured printer cartridges based on the information from the system users. This ranking was transmitted back to the system users via the Internet and land line links as shown in FIG. 1.

Again referring to FIG. 1, the present invention is preferably implemented by an applet resident in the system user's computer. The applet is in the form of a small application program designed to run within the system user's computer's applications. As shown in FIG. 1, applet 108 is running within system user computer 106, applet 114 within system user computer 112, and applet 120 within system user computer 118. The applet may be loaded in a system user computer in a variety of ways. This includes, but is not limited to, downloading the applet from central system 102 to the system user computer via Internet 104, as is possible for computers 106 or 112, or by use of a compact disc (“CD”), as may be the case with regard to computer 118 that is not connected to central system 102 in such a way that electronically downloading the applet would be possible. Further, the applet may be loaded on an electronic circuit of the printer cartridge. So, when the printer cartridge is loaded into the printer, the applet will be uploaded to the computer or printer. The applet also may be loaded on an electronic circuit in the printer. When resident in the printer cartridge or printer, the applet may operate with and through the computer in connecting to the central system. The printer also may connect directly to the central system. For example, the printer could connect to the central system via a wireless connection.

System user computer 106 has printer 110 connected to it, system user computer 112 has printer 116 connected to it, and system user computer 118 has printer 122 connected to it. With the associated computer, each applet will control the operations of the printer connected to that computer. The respective imbedded applets will communicate with, capture, and track the operation of the connected printer. The specific communications and controls will be discussed subsequently.

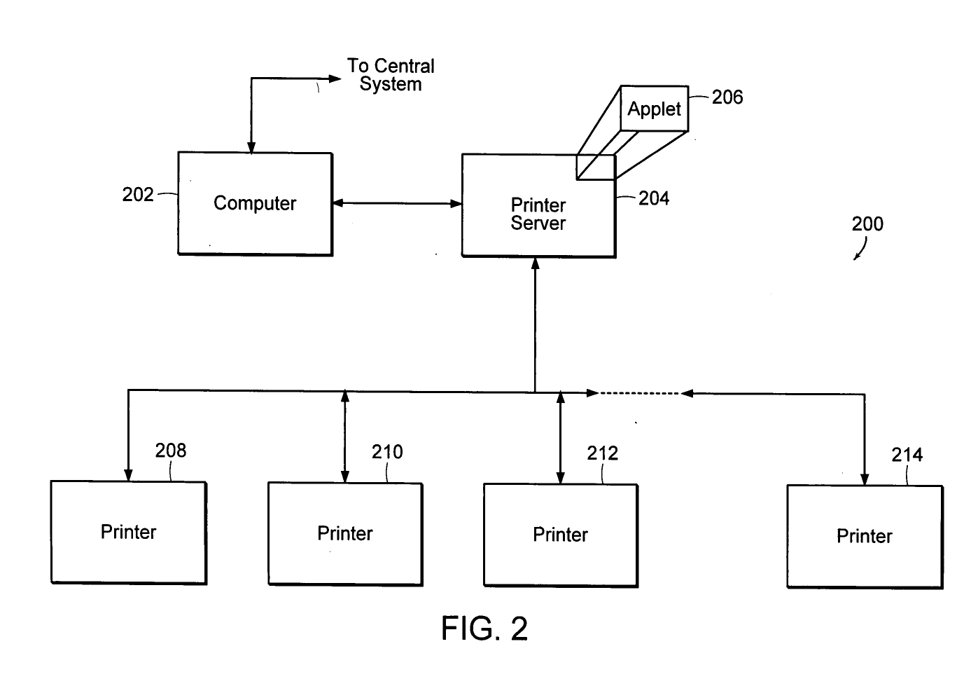

FIG. 2, generally at 200, shows a block diagram of a system user site that has a series of networked computers. The system shown in FIG. 2 may be fully implemented in the system shown in FIG. 1. According to FIG. 2, the system user site has computer 202 that would be operated by IT personnel of the system user. This computer may be connected to central system 102 (FIG. 1) for the exchange of information between the system user and the central system. System user computer 202 connects to printer server 204. Printer server 204 has applet 206 imbedded in it. Computer 202 and printer server 204 control the activity of the networked printers, such as printers 208, 210, 212, and 214. In FIG. 2, only four networked printers are shown, but this Figure also shows that this number may be increased as shown by the connection between printers 212 and 214.

Although FIG. 2 shows printer server 204 connected to central system 102 (FIG. 1) through computer 202, it is within the scope of the present invention that printer server 204 may be connected directly to the central system. Moreover, it is also contemplated that the printer server 204 may include the functions of blocks 202 and 204 and be connected directly to the central system, and still be within the scope of the present invention.

Printer server 204 is shown with applet 206 running within it. This applet would be written with the capability to handle all of the networked printers shown and would be expandable to handle a greater number of networked printers.

The incorporation of the present invention in the systems such as shown in FIG. 1 or 2 would provide the system user with a method to control the number of pages printed and accordingly track printer supply use, i.e., the use of paper and printer cartridges. The applet, such as applets 108, 114, and 120 shown in FIG. 1 and applet 206 shown in FIG. 2, preferably is a software application downloadable from the central system that will run within an application of their respective computers to manage printer usage.

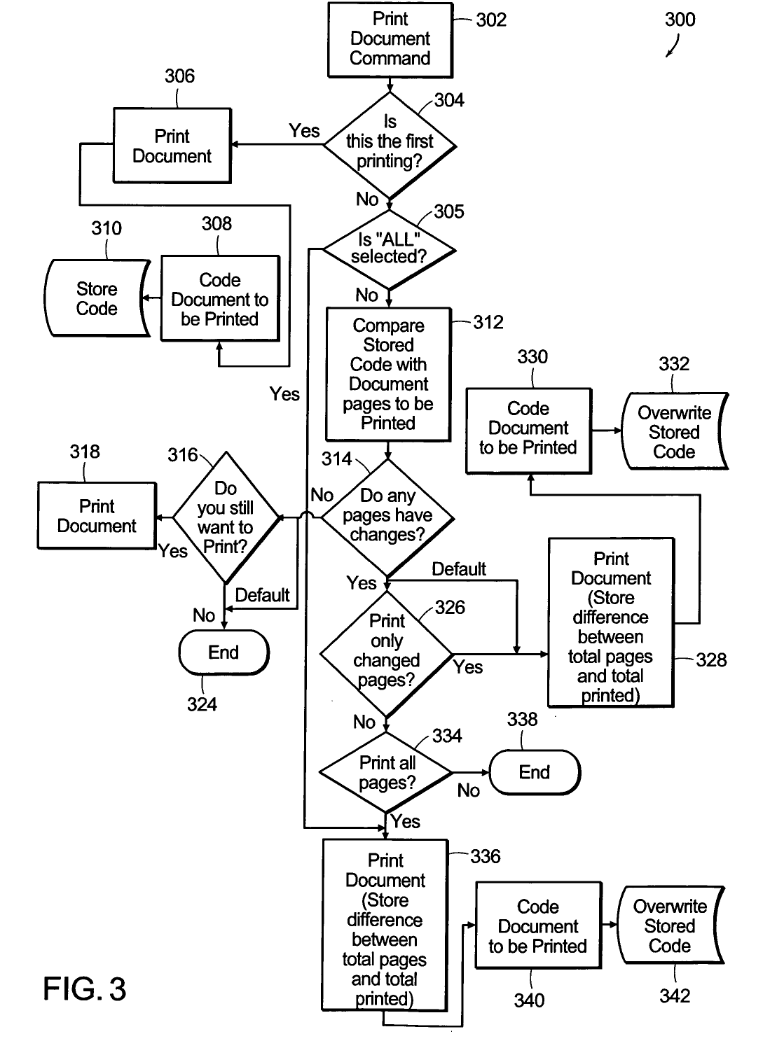

FIG. 3, generally at 300, shows a flow diagram for an applet for the system and method of the present invention. The applet will work with its associated computer to control an associated printer or series of networked printers. In the case of networked printers, such as those shown in FIG. 2, the applet, associated computer, and printer server will be capable of storing the print information relating to each printer individually and the aggregated printers under control of the printer server.

Referring again to FIG. 3, the operation of the applet and associated computer for printer control will be described. When a system user desires to print a document, the user will access print document command 302. This command may be configured in a number of ways according to the present invention. First, it may be configured so that there are two choices in a drop down menu. These may be “ALL” or “CHANGED.” If “ALL” is selected, the printer will be directed to print all of the pages of a document. If, on the other hand, “CHANGED” is selected, the printer will be directed to print only the pages that have been changed since the last time the document was printed. This latter selection will result in a significant savings of paper and printer cartridges over time. However, it is within the scope of the present invention that the system may be configured differently and still be within the scope of the present invention. Some of these other configurations will be discussed herein.

Taking first the configuration of the present invention in which there is a drop down menu that provides “ALL” or “CHANGED” as selections, when either is selected at block 302, the applet will cause the system to move to decision block 304 where it is determined if this is the first printing of a particular document. If it is the first printing, it does not matter if “ALL” or “CHANGED” is selected because the system will proceed to print block 306 to print the entire document. Also at print block 306, the system will determine and then cause to be stored in memory the number of pages that were printed.

Before, as, or after the document is caused to be printed at 306, a representative coded version of the document will be generated at block 308. This coded version of the document will be stored in memory at block 310. The coded version of the documents will be representative of the entire document and the order of the contents in the document.

The coding that has been referred to considers at least the following for each page: the text and font size, a summary of the images, placement of all items on the page, and scaling. It is understood that greater or fewer number considerations may be included and still be within the scope of the present invention.

It is understood that the system user may use conventional printing selections, such as print pages 1-3 of a longer document. Such selections are different from the selections that are provided through the system and method of the present invention.

The system user may change a document that has been printed and thereafter want to print the changed document. If the user selects “ALL” at print document command 302, the system will determine at block 304 that this is not the first printing of the document and will proceed to decision block 305. At block 305, if “ALL” was selected, the system will proceed from this block to print block 336 where the document will be caused to be printed.

Before, as, or after the document has been cause to be printed at block 336, the system will compare the total number of pages of the document with the number of pages of the document that were printed. In this case when all of the pages were printed, this difference will be “0.” This difference value will be stored at a memory location expressly for storing this value. Following this, at block 340, the system will generate a representative coded version of the printed document. At block 342, the representative coded version of the printed document will overwrite the current coded version of the document that is stored in memory.

If a previously printed document has been changed and desired to be printed, the system user may select “CHANGED” in the drop down menu at print document command block 302. When this choice is selected, the system will proceed to decision block 304, but since the document has been previously printed, the system will proceed to decision block 305. At decision block 305, since “CHANGED” was selected, the system will proceed to compare block 312 where the stored coded version of the document will be compared with the document to be printed. Once the comparison is made, the system will proceed to decision block 314 where the determination is made whether the changes to the document actually resulted in any changed pages. For example, the system user may have changed the document to add language to a page and later reverted back to the original language. In this case, there may have been changes but in reality the document pages were not changed. However, if there were changes to the document, the system may be set to proceed by a default setting to print block 328 which will cause only the changed pages of the document to be printed.

The system and method of the present invention may be configured to identify specific types of changes that are to be recognized for the purpose of printing “changed” pages. For example, the system may be configured to recognize changes to page content and certain types of metadata or metatext are not to be recognized. That is, the system may be configured to recognize changes in page content but not changes to page attributes and still be within the scope of the present invention.

Before, as, or after the document is caused to be printed at 328, a representative coded version of the document that was, is being, or will be printed will be generated at block 330. At block 332, this coded version of the document will overwrite the coded version of the document stored in memory. The coded version of the document will be representative of the entire document and the order of the contents, as they now exist.

Before, as, or after the document has been caused to be printed at 328, the system will compare the total number of pages of the document with the number of pages of the document that were printed. This difference value will be added to the stored value at the memory location expressly for storing this value.

The comparison that is made between the stored coded version of the document and the current changed version of the document, for example, at block 312, preferably, is performed using a hashing function. The hashing function that is preferably used is non-linearly distributed hashing function that will show even small changes between input and output values. The use of the hashing function also provides security because the hashing function itself is meaningless to humans. It is contemplated that other methods of comparing the documents may be used and still be within the scope of the present invention as long as these methods will show that there are differences between the two documents.

The system and method of the present invention may be configured so that other printing choices may be made by the system user if “CHANGED” is selected. These other choices will be effective at and after decision block 314.

If it is determined after the comparison at block 312 that the changes did not result in any changed pages, there may be a default setting that would provide an appropriate message to the system user that would indicate there were no changed pages and the system would proceed to end block 324. If, however, the default setting is not activated, the system would proceed to decision block 316 and the system user will be asked if he/she still desires to print the document even though there were no changes to the document. If the system user decides not to print the document, the system will proceed to end block 324. On the other hand, if the system user does decide to print the document, the system will proceed to print block 318 where the document will be caused to be printed. Also, at print block 318, the system will determine the number pages that were printed. This number will be added to the total number of pages printed by the printer. Since there has been no changes to the document, there is not a need to update the coded version of the document stored in memory. Further, since all of the pages of the document were printed, the difference between the total number of pages of the document and number printed will be “0.” As such, there is not a need to update the value stored in memory related to the number of pages saved from being printed.

There may be a number of different types of queries made at blocks 316, 326, and 334 relating to the system user printing documents. For example, there may be a query regarding the desire to print the documents in light of the cost, or the system user having the appropriate permission (password) to print the document, or other types of obligations to be met before printing or liabilities for printing. These and others are within the scope of the present invention.

Again referring to FIG. 3, if, at decision block 314, it is determined that there are changed pages, the system, if the default setting is not activated, will proceed to decision block 326 where the system user will be asked if he/she desires to print only the changed pages. If the system user wants to print these pages, the system will proceed to print block 328 which will cause only the changed pages to be printed.

Before, as, or after the document is caused to be printed at 328, a representative coded version of the document that was, is being, or will be printed will be generated at block 330. At block 332, this coded version of the document will overwrite the coded version of the document stored in memory. The coded version of the document will be representative of the entire document and the order of the contents, as they now exist.

Before, as, or after the document has been caused to be printed at 328, the system will compare the total number of pages of the document with the number of pages of the document that were printed. This difference value will be added to the stored value at the memory location expressly for storing this value.

If the system user determines at block 326 that he/she does not want to print the changed pages at this time, that user would be queried at block 334 if it is desired to print all of the pages of the document. If the system user decides not to print anything, the system will proceed to end block 338. On the other hand, if the system user decides to print all of the pages, the system will proceed to print block 336 where the document will be caused to be printed.

Before, as, or after the document has been cause to be printed at 336, the system will compare the total number of pages of the document with the number of pages of the document that were printed. In this case in which all of the pages were printed, this difference will be “0.” This difference value will be stored at a memory location expressly for storing this value. Following this, at block 338, the system will generate a representative coded version of the document. At block 340, the representative coded version for the printed document will overwrite the current coded version of the document that is stored in memory.

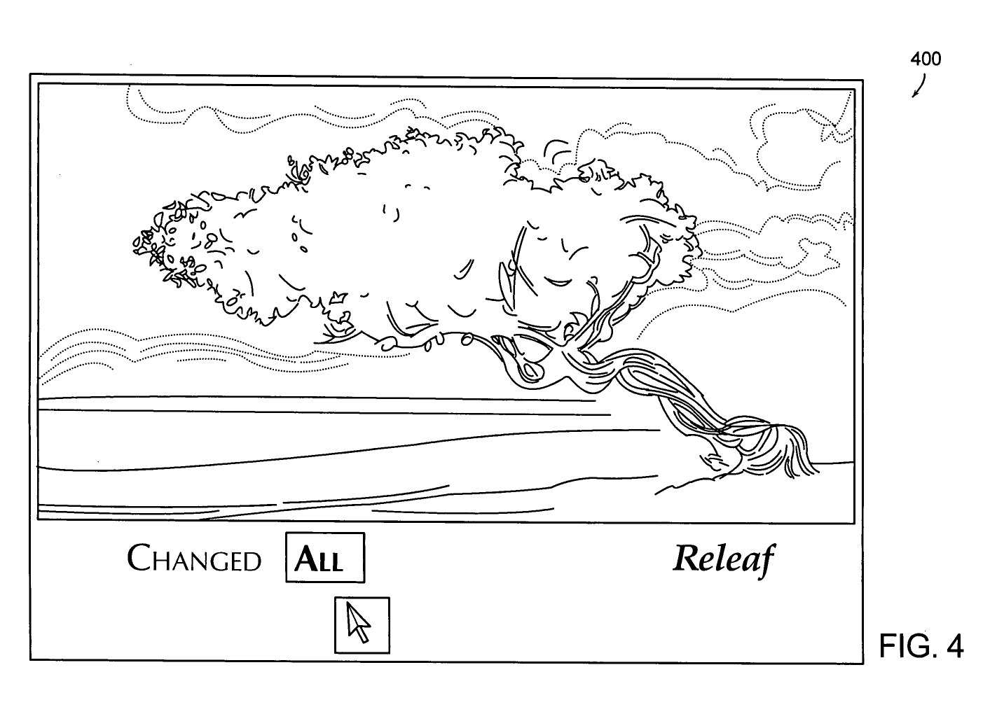

The system and method of the present invention is configurable so that the system user does not have to select between “ALL” or “CHANGED” in a drop down menu. The display screen may provide a print icon as shown in FIG. 4 at 400. This icon only could have “ALL” and “CHANGED” on it so that when either was selected, the commensurate printing activity would take place. Further, the present invention may be configured so that the icon when activated would only print changed pages or all pages as a default action.

Referring to FIG. 4, generally at 400, an icon according to the present invention is shown. This icon may be configured to contain two selections: “CHANGES” and “ALL.” However, it is understood that the icon may include additional selections and still be within the scope of the present invention. For example, there may be two additional selections: “CANCEL” and “>>.” The “CANCEL” selection would cancel the print operation. The “>>” symbol is for additional options, which, for example, may be conventional print options for a computer system.

In the system configurations above, the selection of the “CHANGED” option not only provides the system user with significant paper savings, it will also provide significant savings in remanufactured printer cartridges. This latter situation provides a double savings. The first is the remanufactured printer cartridges cost significantly less than new printer cartridges and the second is that fewer unneeded pages are printed so less ink/toner is used, thereby extending the life of the printer cartridges.

In the configuration in which a special print icon is used, the present invention may provide print data at certain times in the icon. For example, the aggregate number of pages saved may be provided in the icon at certain times. This will remind the system user of the savings but inculcate user friendliness and encourage user compliance. This information may also include, for example, the number of trees saved commensurate with the number of pages that were saved from being printed. Further, the icon background may be change based on savings performance or for other reasons associated with benefits provided by the present invention. Also, the icon backgrounds may reflect the system user's participation in the environmental benefits of the present invention.

As set forth above, present invention, among other things, tracks the number pages that have been saved by the “CHANGED” option being used. This statistical information may be used in rewards programs or system user access to discounts on printer supplies with participating members. This savings information may be uploaded to central system (FIG. 1) where with the appropriate authorizations, the system user may be recognized, for example, for its environmental record through the use of the present invention. Moreover, feedback information from the system users relating to the quality, for example, of particular printer cartridges new or remanufactured that is uploaded to, and aggregated by, the central system will permit the central system to provide recommendations to the system users for sources of printer supplies which would meet desired needs of system users, for example, for an environmentally friendly paper supplier who provides discounts for environmentally conscious users like that system user.

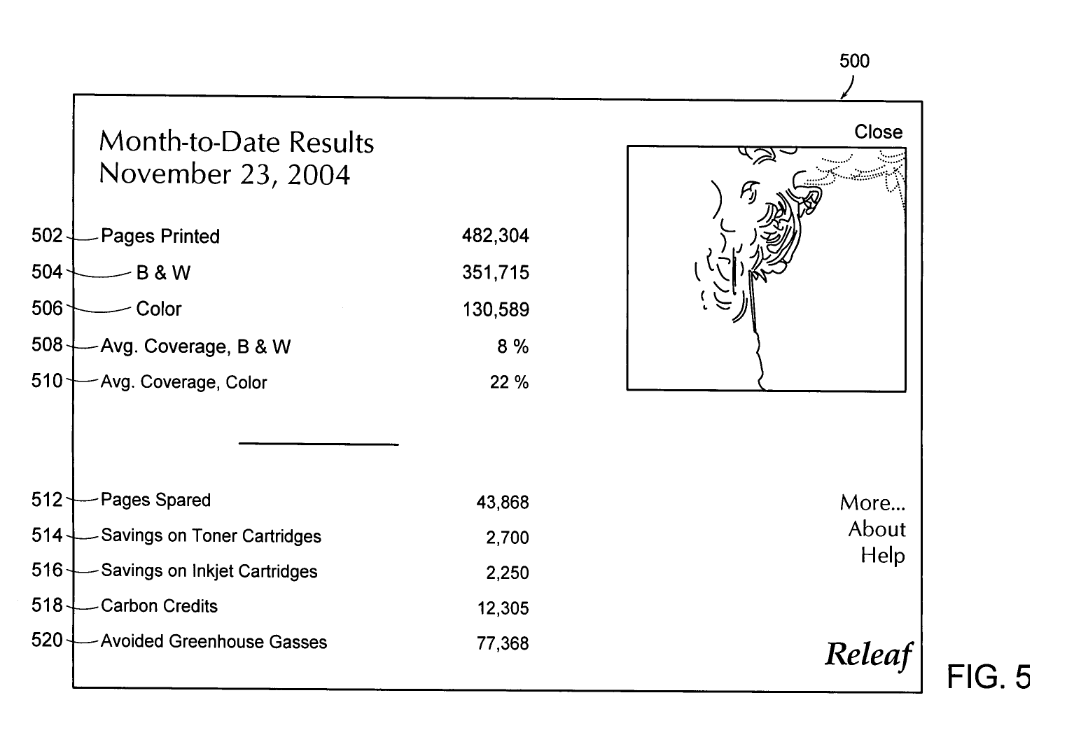

Referring to FIG. 5, generally at 500, a computer display icon is shown that includes various information that is being tracked according to the present invention. At 502, the icon shows the total number of pages printed, and at 504 and 506, it shows the total number of printed pages that were black and white (504) and color (506). Further, at 508, it shows the average amount of coverage associated with the printed black and white pages and at 510 the average coverage associated with the printed color pages.

The final section of the display icon 500 provides the savings data. At 502, it shows the total number of pages saved from being printed. In light of the saved pages, the icon shows the direct correlation to the number of toner cartridges (514) and ink jet (516) cartridges saved. Further, the paper savings is directly correlated to the numbered resources saved which in this icon are the carbon credits earned (516) and greenhouse gases avoided (520). These savings and amounts are just representative and others may be added and still be within the scope of the present invention.

System users through feedback may also provide evaluation information back to the central system regarding the quality of the printer supplies that it has been using. If, for example, the system user has had a positive experience with particular remanufactured printer cartridges, this may be communicated to the central system so that other system users would be privy to this information. Further, the central system may also provide recommendations to system users based on the uploaded information according to the type of printing operations performed by the system user. For example, if the system user is printing fliers that do not require high quality paper or ink/toner, the central system can make recommendations of paper producers and printer cartridges remanufacturers who meet these needs but who also are in keeping with the system users environmentally friendly requirements for its suppliers.

The communication from the central system to the system users also may be incentives to the system users in the form of icon displays that encourage the system user to continue or begin activities in a particular way, e.g., show icon background that demonstrates the environmental impact of the system user activities in saving paper.

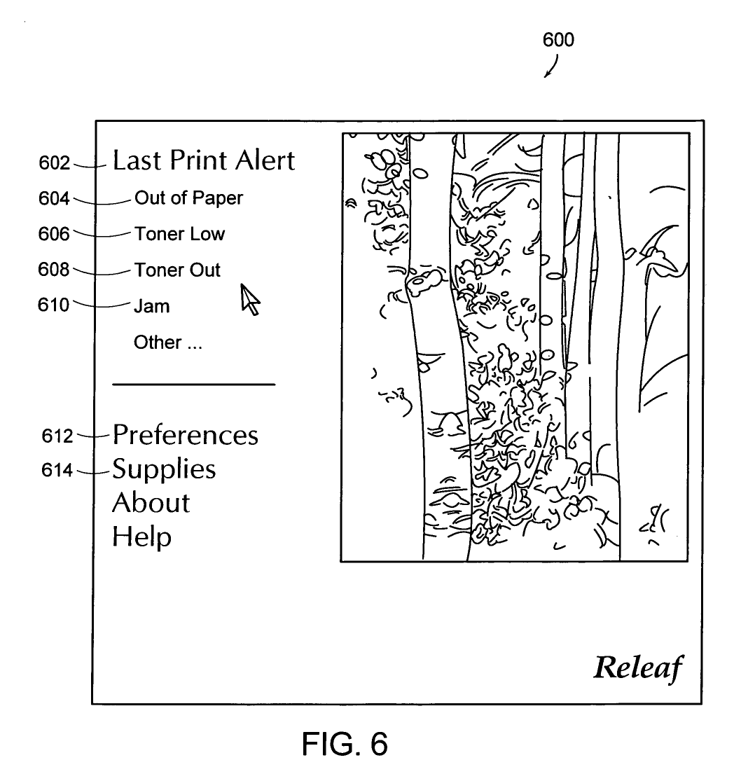

Referring to FIG. 6, generally at 600, a computer display icon is provided that tracks the printer supplies and some printer status. At 602, the icon provides the “Last Print Alert” to indicate the status of printer supplies. These are “Out of Paper” at 604, “Toner Low” at 606, and “Toner Out” at 608. If the printer is not working because of a paper jam, the icon will so indicate at 610. “Other” at 610 will indicate other status conditions of the printer.

“Preferences” at 612 will provide the system user with options for customizing system operation. “Supplies” at 614 will provide the system user, for example, with rankings and other aggregated information from the central system.

In order for the present invention to be able to carry out its monitoring feature of printing activities, it captures the print stream. The capture of the print stream will mean the present invention will monitor the print stream at all times. The capture of the print stream will permit the system owner to detect any irregularities in the use of printers. Among other things, the monitoring can detect abuse and security breaches by users. This will permit the system user to determine when a printer is used and for what purpose. For example, this will help ensure compliance with HIPAA, intelligence service Acts, Sarbanes-Oxley, or Gramm-Leach-Bliley. This control of printer use is also a deterrent to abuse.

The present invention codes the pages of each document. As such, the present invention can determine the amount of page coverage for each page. Typically, printing services providers charge customers based on an average price of the paper and ink/toner coverage per page. For example, a typical black and white typed page includes about 5% coverage of the page. However, a color printed page may cover more than 75% of the page meaning that the actual ink/toner costs are significantly higher. This is why color pages cost more than black and white pages to print because this average coverage by color pages is greater. This average price is usually reduced to a flat fee charged to customers. However, the flat fee approach may, in fact, result in the printing services provider undercharging or overcharging for printing services. Therefore, it is very helpful to know the exact amount of ink used so that an accurate amount may be charged for printing services.

Since the cost of paper and ink/toner are accurately determined according to the present invention, this printing services provider can charge an appropriate amount based on the actual paper and ink/toner coverage costs for each page printed. The determination of the actual coverage is performed by the coding of the document pages. As stated, the coding will indicate at least text and font size, a summary of the images, placement of items on a page, and scaling.

The terms and expressions that are employed herein are terms of description and not of limitation. There is no intention in the use of such terms and expressions of excluding the equivalents of the feature shown or described, or portions thereof, it being recognized that various modifications are possible within the scope of the invention as claimed.

1. A method for controlling printing of pages of a document with a printer device, comprising the steps of:
(a) preparing with a computer based system connected to the printer device a document of at least one page that has been printed at least one time previously for printing by the printer device at least a second time;
(b) comparing the document pages to be printed with a stored version of the document pages representative of a last printing of each document page;
(c) determining which document pages of the document pages to be printed include changes from the last printing of that document page; and
(d) automatically printing only the pages that have changes based on the comparison at step (b) and the determination at step (c).

2. The method as recited in claim 1, wherein the determination of changes at step (c) includes changes in printing content.

3. The method as recited in claim 1, wherein the determination of changes at step (c) includes changes in image content.

4. The method as recited in claim 1, wherein the determination of changes at step (c) includes change in free area of a page.

5. The method as recited in claim 1, wherein the comparing at step (b) includes using a hashing function.

6. The method as recited in claim 5, wherein the comparing at step (b) includes using a non-linearly distributed hashing function.

7. A method for controlling printing of pages of a document with a printer device, comprising the steps of:
(a) preparing with a computer based system connected to the printer device a document for printing by the printer device;
(b) printing the document for a first time with the printer device and storing in an electronic storage means of the computer based system a retrievable version of the document that is or was printed by the printer device;
(c) making at least one change to the content of at least one page of the document that was printed at step (b);
(d) preparing with the computer based system connected to the printer device to print the document that has at least one change to the content of at least one page;
(e) retrieving from the electronic storage means the version of the document stored at step (b) and comparing the stored version of the document with the document that has at least one change to the content of at least one page and determining at least the specific page of the document that was prepared to be printed at step (d) that has at least one change thereon; and
(f) automatically printing only the page that has the change thereon based on the comparison and determination at step (e).

8. The method as recited in claim 7, wherein the determination of change at step (c) includes changes in printing content.

9. The method as recited in claim 7, wherein the determination of changes at step (c) includes changes in image content.

10. The method as recited in claim 7, wherein the determination of changes at step (c) includes change in free area of a page.

11. The method as recited in claim 7, wherein the comparing at step (e) includes using a hashing function.

12. The method as recited in claim 11, wherein the comparing at step (e) includes using a non-linearly distributed hashing function.

13. A method for controlling printing of pages of a document with a printer device, comprising the steps of:
(a) preparing with a computer based system connected to the printer device a document for printing by the printer device;
(b) printing the document with the printer device and storing in an electronic storage means of the computer based system a retrievable version of the document that is or was printed by the printer device;
(c) making at least one change to the content of at least one page of the document that was printed at step (b);
(d) preparing with the computer based system connected to the printer device to print the document that has at least one change to the content of at least one page;
(e) retrieving from the electronic storage means the version of the document stored at step (b) and comparing the stored version of the document with the document that has at least one change to the content of at least one page and determining at least the specific page of the document that was prepared to be printed at step (d) that has at least one change thereon; and
(f) automatically printing only the page that has the change thereon based on the comparison and determination at step (e).

14. The method as recited in claim 13, wherein the determination of change at step (c) includes changes in printing content.

15. The method as recited in claim 13, wherein the determination of changes at step (c) includes changes in image content.

16. The method as recited in claim 13, wherein the determination of changes at step (c) includes change in free area of a page.

17. The method as recited in claim 13, wherein the comparing at step (b) includes using a hashing function.

18. The method as recited in claim 17, wherein the comparing at step (b) includes using a non-linearly distributed hashing function.

19. A computer based system for controlling printing of pages of a document with a connected printer device, comprising:
(a) the computer based system having means for preparing to print with the connected printer device printer a previously printed document that has at least one page that has at least one change thereon since a last printing;
(b) the computer based system having means for comparing the document pages to be printed with a stored version of the document pages representative of the document at the last printing of each document page;
(c) the computer based system having means for determining which document pages of the document pages to be printed include changes from the last printing of that document page; and
(d) the computer base system having means for causing the printing by the printer device only the pages that have changes thereon.

20. The system as recited in claim 19, wherein the comparing means includes means that uses a hashing function.

21. The system as recited in claim 20, wherein the comparing means includes means that uses a non-linearly distributed hashing function.

22. A computer based method for reducing the cost of printing documents on a connected printer device that includes a remanufactured or refurbished printer cartridge, comprising the step of:
(a) printing the a document with the printer device;
(b) storing a version of the document printed at step (a) in an electronic storage means;
(c) making at least one change to at least one page of the document that was printed at step (a) and preparing to print the document with at least one change to at least one page of the document;
(d) comparing the stored version of the document with the document with at least one change to at least one page of the document;
(e) printing only the pages of the document prepared to be printed at step (c) that have changes thereon; and
(f) overwriting the version of the document stored at step (b) with a version of the document that includes at least one change to at least on page.

23. The method as recited in claim 22, wherein the comparing at step (d) includes using a hashing function.

24. The method as recited in claim 23, wherein the comparing at step (d) includes using a non-linearly distributed hashing function.

25. A computer based method for determining the cost for printing a document, comprising the steps of:
(a) determining an incremental cost of media upon which a content of a page will be disposed;
(b) determining for each page of the document to be printed the amount of a printing substance that is used to dispose the content on the media for that page;
(c) determining an incremental cost of a predetermined amount of the printing substance;
(d) determining the cost for the document being printed based on the steps (a), (b), and (c);
(e) printing the document; and
(f) charging a printing cost based on the step (d).

26. The method as recited in claim 25, wherein step (b) includes determining by coding an amount of printing substance coverage that is used to dispose the content on the media for the page.

27. A method for ranking quality of remanufactured printer cartridges, comprising the steps of:
(a) a central system connecting to a plurality of system users with each user having at least a computer based system with a connected printer device and the printer device using a remanufactured printer cartridge;
(b) each system user using the remanufactured printer cartridges of one or more identifiable remanufacturers and evaluating each remanufactured printer cartridge on a predetermined set of evaluation criteria determined by the central system;
(c) each system user uploading to the central system the evaluation of the remanufactured printer cartridges it used based on the predetermined set of evaluation criteria for each identifiable remanufacturer;
(d) the central system aggregating the evaluations from the plurality of system users and ranking the remanufactured printer cartridges according to the predetermined set of evaluation criteria; and
(e) transmitting the ranking of remanufactured printer cartridges to the plurality of system users for use in selecting remanufactured printer cartridges to purchase.

28. The method as recited in claim 27, wherein the predetermined set of evaluation criteria includes the print quality produced by the remanufactured printer cartridge.

29. The method as recited in claim 27, wherein the predetermined set of evaluation criteria includes a length of life of the remanufactured printer cartridge.

30. The method as recited in claim 27, wherein the predetermined set of evaluation criteria includes the existence of electronic circuits in the remanufactured printer cartridge.

31. The method as recited in claim 30, wherein the predetermined set of evaluation criteria includes the existence of programmable electronic circuits in the remanufactured printer cartridge.

32. A method of representing to a system user an amount of non-financial saving accrued by printer device control, comprising the steps of:
(a) preparing with a computer based system connected to the printer device a document for printing by the printer device;
(b) printing the document for a first time with the printer device and storing an electronic storage means of the computer based system a retrievable version of the document that is or was printed by the printer device;
(c) making at least one change to the content of at least one page of the document that was printed at step (b);
(d) preparing with the computer based system connected to the printer device to print the document that has at least one change to the content of at least one page;
(e) retrieving from the electronic storage means the version of the document stored at step (b) and comparing the stored version of the document with the document that has at least one change to the content of at least one page and determining at least the specific page of the document that was prepared to be printed at step (d) that has at least one change thereon;
(f) automatically printing only the page that has the change thereon based on the comparison and determination at step (e);
(g) determining a number of pages saved from being printed by only printing the pages that have changes thereon;
(h) translating a savings in a resource based on printing only the pages that have changes thereon; and
(i) displaying on display means a representation indicative of the amount of the resource being saved.

33. The method as recited in claim 32, wherein the resource includes a natural resource.

34. The method as recited in claim 33, wherein the natural resource includes wood.

35. The method as recited in claim 32, wherein the representation at step (i) includes an image.

36. The method as recited in claim 32, wherein the representation at step (i) includes a printed statement.

37. A method for controlling printing of pages of a document with a printer device, comprising the steps of:
(a) preparing with a computer based system connected to the printer device a document for printing by the printer device;
(b) printing the document with the printer device and storing an electronic storage means of the computer based system a retrievable version of the document that is or was printed by the printer device;
(c) making at least one change to the content of at least one page of the document that was printed at step (b);
(d) preparing with the computer based system connected to the printer device to print the document that has at least one change to the content of at least one page;
(e) retrieving from the electronic storage means the version of the document stored at step (b) and comparing the stored version of the document with the document that has at least one change to the content of at least one page and determining at least the specific page of the document that was prepared to be printed at step (d) that has at least one change thereon;
(f) automatically printing only the page that has the change thereon based on the comparison and determination at step (e);
(g) determining a number of pages saved from being printed by only printing the pages that have changes thereon;
(h) translating a savings in a resource based on printing only the pages that have changes thereon; and
(i) displaying on display means a representation indicative of the amount of the resource being saved.

38. The method as recited in claim 37, wherein the resource includes a natural resource.

39. The method as recited in claim 38, wherein the natural resource includes wood.

40. The method as recited in claim 37, wherein the representation at step (i) includes an image.

41. The method as recited in claim 37, wherein the representation at step (i) includes a printed statement.
